(19) United States
(12) Patent Application Publication
(10) Pub. No.: US 2026/0295829 A1
(43) Pub. Date: Oct. 1, 2026

(54) METHOD FOR THE DYNAMIC DETECTION OF RATCHETING IN A COLLABORATIVE ROBOT BY MEANS OF ARTIFICIAL INTELLIGENCE AND DYNAMIC COMPENSATION OF THE TRAJECTORIES

(71) Applicant: Schaeffler Technologies AG & Co. KG, Herzogenaurach (DE)

(72) Inventor: Kazuaki Kaneko, Yokohama (JP)

(73) Assignee: Schaeffler Technologies AG & Co. KG, Herzogenaurach (DE)

(21) Appl. No.: 18/881,498

(22) PCT Filed: Jun. 23, 2023
(86) PCT No.: PCT/DE2023/100476

§ 371 Date: Jan. 6, 2025

(30) Foreign Application Priority Data
Jul. 7, 2022 (DE) 10 2022 116 969.3

(51) Int. Cl. B25J 9/16

(52) U.S. Cl. CPC B25J 9/1653; B25J 9/163; G05B 2219/39001

(57) ABSTRACT

The invention relates to a method for the detection of ratcheting during operation of a robot, in particular a collaborative robot, in relation to at least one joint of the robot, in particular of the collaborative robot, on the basis of operating data of the robot by means of artificial intelligence comprising the following steps: providing of operating data, in particular current flow data, in relation to a time behaviour of a motor, in particular a servomotor, of a robot; detecting of ratcheting of a joint of the robot, in particular in the case of a strain wave gear mechanism, a harmonic drive and/or ellipto-centric gear mechanism, by evaluation of the operating data as indirect or direct input data for an artificial intelligence system yielding output data, wherein the output data of the artificial intelligence system comprise an indicator which indicates whether ratcheting has occurred in relation to the joint, in particular the gear mechanism.

### CROSS-REFERENCE TO RELATED APPLICATIONS

This application is a U.S. national stage application under 35 U.S.C. § 371 that claims the benefit of priority under 35 U.S.C. § 365 of International Patent Application No. PCT/DE2023/100476, filed on Jun. 23, 2023, designating the United States of America, which in turn claims the benefit of priority under 35 U.S.C. §§ 119, 365 of German Patent Application No. 102022116969.3, filed Jul. 7, 2022, the contents of which are relied upon and incorporated herein by reference in their entirety.

### FIELD OF THE DISCLOSURE

The present disclosure relates generally to the technical field of robotics, autonomous mobile robots (AMRs), and in particular collaborative robots (cobots) and safety and precision engineering in the workplace and in assembly systems.

### BACKGROUND OF THE DISCLOSURE

Cobot systems have been used in more and more facilities in recent years. This has led to human workers increasingly sharing the same space with cobot systems. Such robots are designed with particularly collaborative properties. For example, movements should first be stopped if objects or workers are in the way to prevent damage and injuries. Strain wave gear mechanisms (harmonic drives/harmonic gear boxes) are often used as gear mechanisms. In this case, in particular during collision-stopped movements, a process can occur which is often referred to as ratcheting. The internal teeth of a gear mechanism can slip or be displaced against each other by, for example, one tooth, but also by a plurality of teeth.

It is difficult to correctly determine this ratcheting, both quantitatively and qualitatively. If ratcheting is not taken into account, for example, or if ratcheting that has occurred remains unobserved, among other things, it may be that a robot- and thus also the end effector-stops in the wrong end positions, etc.

U.S. Pat. No. 7,439,693B2 discloses a method for detecting anomalies and a motor control device. The method for detecting anomalies in a linear motion device, wherein a motor control device of a motor that drives a movable body of a linear motion device, has the following steps: detecting a position or a speed of the movable body; performing feedback control to supply current or voltage to the motor based on the detection result; and detecting an anomaly of the linear motion device based on an abnormal signal component included in a waveform of the supply current or the supply voltage.

Here, a control unit of a motor driver performs feedback control to supply power to a linear motor based on a detection value of a linear encoder. An anomaly detection unit monitors the supply current to the linear motor, and the anomaly detection unit detects an anomaly of a linear motion device based on a waveform of the supply current. When an anomaly is detected, the user is alerted by means of a lamp, buzzer, email or similar. Therefore, the anomaly of the linear motion device can be detected early and accurately.

### SUMMARY OF THE DISCLOSURE

The present disclosure provides a method for the detection of ratcheting during operation of a robot, in particular a collaborative robot (cobot), in relation to at least one joint of the robot, in particular of the cobot, on the basis of operating data of the robot by means of artificial intelligence comprising the following steps: providing operating data, in particular current flow data, in relation to a time behavior of a motor, in particular a servomotor, of a robot; detecting ratcheting of a joint of the robot, in particular in the case of a strain wave gear mechanism, a harmonic drive and/or an ellipto-centric gear mechanism, by evaluation of the operating data as indirect or direct input data for an artificial intelligence system yielding output data, wherein the output data of the artificial intelligence system comprise an indicator which indicates whether ratcheting has occurred in relation to the joint, in particular the gear mechanism.

The artificial intelligence system determines particularly precisely whether ratcheting has occurred. The precision is higher than with conventional methods.

For example, the time behavior of a current flow is described by data that can serve as input data for the artificial intelligence system.

This allows the AI system to classify whether ratcheting occurred during the time period in question or not. For example, ratcheting can also be quantified. For example, in a strain wave gear mechanism, it can be determined how many teeth were skipped during ratcheting.

The AI system also performs this task with greater precision than is the case with other or known methods.

The disclosure further provides a cobot comprising a robotic device, in particular a robot arm and/or an assembly system, wherein the robotic device has one or more joints which can be moved by motors, in particular servomotors, one or more motor control units for controlling the motors, wherein the cobot is further configured to use the artificial intelligence system to detect ratcheting of a joint, in particular in a strain wave gear mechanism, harmonic drive and/or ellipto-centric gear mechanism, by evaluating operating data as indirect or direct input data for the artificial intelligence system, wherein the operating data comprise data, in particular current flow data, in relation to a time behavior of a motor of the robot.

In addition, the disclosure provides an artificial intelligence system and a suitable training method. Thus, according to the disclosure, an artificial intelligence system, in particular linear and/or non-linear regression, fast Fourier transform and/or a support vector machine and/or an artificial neural network, in particular a recurrent neural network, is provided, which is configured to determine the presence or absence of ratcheting of a gear mechanism, in particular in a cobot, and/or to determine a number of teeth that were skipped in a gear mechanism during ratcheting, comprising one or more input neurons for receiving input data comprising data on the basis of operating data, in particular current flow data, in relation to a time behavior of a motor, in particular a servomotor.

According to a further development, the artificial intelligence system is designed to provide output data which comprise an indicator which indicates whether ratcheting has occurred in relation to the joint, in particular the gear mechanism.

Thus, the appropriately trained AI system can immediately and reliably produce such labels that describe the presence or absence of ratcheting. For example, such labels can be expressed by “0” and “1”, where “1” describes a ratcheting that has occurred. Appropriate technical corrective actions are reliably enabled.

According to a further development, output data further indicate an extent of ratcheting that has occurred, if such has occurred, in particular a number of teeth that were skipped in a gear mechanism during ratcheting, and/or an angle skipped by the ratcheting.

Thus, the appropriately trained AI system can immediately and reliably produce such labels that quantify ratcheting. For example, such labels can be expressed as “0”, “1”, “2”, “3”, etc., where the number indicates how many teeth were skipped. This labeling of the Al system is a more precise determination than that based on conventional methods. Appropriate technical corrective actions are reliably enabled.

According to a further development, the cobot is further configured to calculate a corrected trajectory and/or corrected control instruction, in particular on the basis of the number of teeth skipped during ratcheting and/or on the basis of the angle skipped by the ratcheting.

For example, a value for a current angle is corrected in the control unit so that after ratcheting occurs, it again corresponds to the angle actually present on the robot.

Thus, the determination of the AI system can be used for improved dynamic behavior of the robotic device.

According to a further development, the cobot comprises a central control unit and at least one motor control unit, wherein the central control unit and the motor control unit can communicate with each other via a bus, in particular an Ethernet bus, wherein in particular a determination as to whether ratcheting has occurred in relation to a joint takes place in an associated motor control unit, wherein in particular a determination of a number of teeth which were skipped in a gear mechanism during ratcheting takes place in an associated motor control unit, wherein in particular a calculation of a corrected trajectory and/or corrected control instruction takes place in the central control unit. This division of labor and communication between the central control unit and the motor control units is particularly resource-efficient, enabling effective ratcheting detection and dynamic correction in real time.

### BRIEF DESCRIPTION OF THE DRAWINGS

Preferred embodiments of the present disclosure are described below with reference to the following figures:

FIG. 1 shows a flow chart (in the form of a repeat loop) for a central control unit for detecting ratcheting according to embodiments of the disclosure, including compensation.

FIG. 2 shows a flow chart (in the form of a repeat loop) for a motor control unit for detecting ratcheting according to embodiments of the disclosure, including quantitative determination of the skipped teeth.

### DETAILED DESCRIPTION

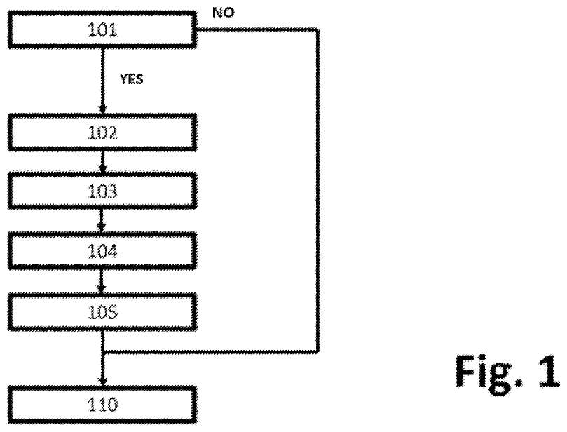

FIG. 1 shows a flow chart (in the form of a repeat loop) for a central control unit for detecting ratcheting according to embodiments of the disclosure, including compensation.

In step 101, it is checked whether a ratcheting error (ratcheting occurrence) has been received from a joint (or its motor control unit).

If this is the case, a value for a currently occupied angle is corrected in step 102. It is corrected by the angle caused by ratcheting. For example, it depends on a number of skipped teeth and/or on one or more total numbers of teeth present in the corresponding gear mechanism.

For example, a special mode is assumed by the central control unit, which is only assumed if ratcheting has been observed.

In step 103, corresponding variables for current end effector positions of the cobot are updated. In an example, this is a calculation that builds on the result from step 102. In step 104, a trajectory that the joint is to traverse in the future is recalculated or updated. For example, this is calculated in such a way that the robot can achieve a configuration that would have occurred if ratcheting had not occurred. However, other behaviors are also conceivable. For example, an LSPB method (linear segments with parabolic blends) is used to calculate the trajectory.

In step 105, the central control unit returns to a normal mode. This is the mode that is normally used unless ratcheting occurs. This is the mode in which the central control unit was at the beginning 101 of the flow chart.

The flow chart finishes with the end 110.

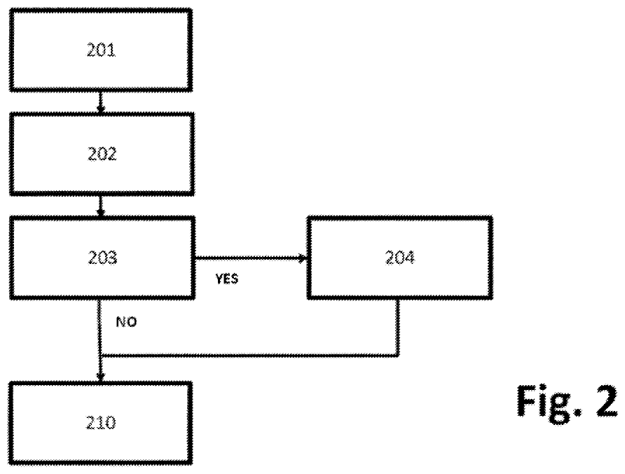

FIG. 2 shows a flow chart (in the form of a repeat loop) for a motor control unit for detecting ratcheting according to embodiments of the disclosure, including quantitative determination of the skipped teeth.

In step 201, time behavior data, for example a motor current flow of a joint motor, is loaded into a calculation buffer. In step 202, the AI system according to the disclosure is used to determine whether ratcheting has occurred at the joint (and, if necessary, quantifies it). If ratcheting is positively detected at the decision point 203, a corresponding ratcheting error code is output to a communication bus at step 204. This allows the central control unit to learn of the error/ratcheting. For example, the error code contains information about how many teeth were skipped.

The flow chart finishes with the end 210.

The embodiments described schematically here can be further developed by numerous details of the disclosure, in particular by those already described above.

Although some aspects have been described in the context of a device, it is clear that these aspects also constitute a description of the corresponding method, wherein a block or device corresponds to a method step or a function of a method step. Similarly, aspects described in the context of a method step also represent a description of a corresponding block or element or a property of a corresponding device.

Exemplary embodiments of the disclosure can be implemented in a computer system. The computer system can be a local computer device (for example a personal computer, laptop, tablet computer, or cell phone) having one or more processors and one or more storage devices, or can be a distributed computer system (for example a cloud computing system having one or more processors or one or more storage devices distributed at various locations, for example, at a local client and/or one or more remote server farms and/or data centers). The computer system may comprise any circuit or combination of circuits. In one exemplary embodiment, the computer system may comprise one or more processors, which may be of any type. As used herein, processor may mean any type of computing circuit, such as, but not limited to, a microprocessor, a microcontroller, a complex instruction set computer (CISC), a reduced instruction set computer (RISC), a very long instruction word (VLIW) microprocessor, a graphics processor, a digital signal processor (DSP), a multi-core processor, a field-programmable gate array (FPGA), or any other type of processor or processing circuit. Other types of circuitry that the computer system may comprise may be a custom-built circuit, an application-specific integrated circuit (ASIC), or the like, such as one or more circuits (e.g., a communications circuit) for use with wireless devices such as cell phones, tablet computers, laptop computers, two-way radios, and similar electronic systems. The computer system may comprise one or more storage devices, which may comprise one or more storage elements suitable for the particular application, such as main memory in the form of random access memory (RAM), one or more hard disks, and/or one or more drives handling removable media such as CDs, flash memory cards, DVDs, and the like. The computer system may also comprise a display device, one or more speakers, and a keyboard and/or controller, which may include a mouse, trackball, touch screen, voice recognition device, or any other device that allows a system user to enter information into and receive information from the computer system.

Some or all of the method steps can be carried out by (or using) a hardware device, such as a processor, a microprocessor, a programmable computer or an electronic circuit. In some exemplary embodiments, one or more of the key method steps can be carried out by such a device.

Depending on certain implementation requirements, exemplary embodiments of the disclosure can be implemented using hardware or software. The implementation may be carried out with a non-volatile storage medium such as a digital storage medium, such as a floppy disk, a DVD, a Blu-Ray disk, a CD, a ROM, a PROM and EPROM, an EEPROM, or a FLASH memory on which electronically readable control signals are stored that interact (or can interact) with a programmable computer system to perform the respective method. Therefore, the digital storage medium can be computer-readable.

Some exemplary embodiments according to the disclosure comprise a data carrier with electronically readable control signals that can interact with a programmable computer system so that one of the methods described herein is carried out.

In general, exemplary embodiments of the present disclosure may be implemented as a computer program product having a program code, wherein the program code is effective for carrying out one of the methods when the computer program product is running on a computer. The program code can, for example, be stored on a machine-readable medium.

Further exemplary embodiments comprise the computer program for carrying out one of the methods described herein, which is stored on a machine-readable medium.

In other words, an exemplary embodiment of the present disclosure is therefore a computer program with a program code for carrying out one of the methods described herein when the computer program runs on a computer.

A further exemplary embodiment of the present disclosure is thus a storage medium (or data carrier or computer readable medium), comprising a computer program stored thereon for carrying out one of the methods described herein when executed by a processor. The data carrier, the digital storage medium or the recorded medium are usually tangible and/or non-transitory. A further exemplary embodiment of the present disclosure is a device as described herein, comprising a processor and the storage medium.

A further exemplary embodiment of the disclosure is therefore a data stream or a signal sequence representing the computer program for carrying out one of the methods described herein. For example, the data stream or signal sequence can be configured to be transmitted over a data communication connection, for example over the Internet.

Another exemplary embodiment comprises a processing means, for example a computer or a programmable logic device, configured or adapted to perform any of the methods described herein.

A further exemplary embodiment comprises a computer on which the computer program for carrying out one of the methods described herein is installed.

Another exemplary embodiment according to the disclosure comprises a device or system configured to transmit (e.g., electronically or optically) a computer program for carrying out one of the methods described herein to a receiver. The receiver may be, for example, a computer, a mobile device, a storage device or the like. The device or system may, for example, comprise a file server for transmitting the computer program to the receiver.

In some exemplary embodiments, a programmable logic device (e.g., a field programmable gate array, FPGA) may be used to perform some or all of the functionality of the methods described herein. In some exemplary embodiments, a field programmable gate array may cooperate with a microprocessor to carry out any of the methods described herein. In general, the methods are preferably carried out by each hardware device.

Exemplary embodiments may be based on the use of a machine learning model and/or machine learning algorithm (i.e., artificial intelligence). Machine learning can refer to algorithms and statistical models that computer systems can use in order to perform a certain task without using explicit instructions, rather than relying on models and inference. In machine learning, for example, instead of a transformation of data based on rules, a transformation of data can be used that can be derived from an analysis of historical and/or training data. For example, the content of images can be analyzed using machine learning or using a machine learning algorithm. In order for the machine learning model to analyze the content of an image, the machine learning model can be trained using training images as input and training content information as output. By training the machine learning model with a large number of training images and/or training sequences (e.g., words or sentences) and associated training content information (e.g., labels or annotations), the machine learning model “learns” to recognize the content of the images, so that the content of images not included in the training data can be recognized using the machine learning model. The same principle can also be used for other types of sensor data: By training a machine learning model using training sensor data and a desired output, the machine learning model “learns” a transformation between the sensor data and the output, which can be used to provide an output based on non-training sensor data provided to the machine learning model. The data provided (for example sensor data, metadata and/or image data) can be pre-processed in order to obtain a feature vector, which is used as input for the machine learning model.

Machine learning models can be trained using training input data. The examples above use a training method called supervised learning. In supervised learning, the machine learning model is trained using a plurality of training sample values, wherein each sample value can comprise a plurality of input data values and a plurality of desired output values, i.e., each training sample value is associated with a desired output value. By specifying both training sample values and desired output values, the machine learning model “learns” which output value is to be provided based on an input sample value that is similar to the sample values provided as part of the training. In addition to supervised learning, semi-supervised learning can also be used. In semi-supervised learning, some of the training sample values are missing a desired output value. Supervised learning can be based on a supervised learning algorithm (for example, a classification algorithm, a regression algorithm or a similarity learning algorithm). Classification algorithms can be used when the outputs are restricted to a limited set of values (categorical variables), i.e., the input is classified as one value of the limited set of values. Regression algorithms can be used if the outputs show any numerical value (within a range). Similarity learning algorithms can be similar to both classification and regression algorithms, but are based on learning from examples using a similarity function that measures how similar or related two objects are. In addition to supervised learning or semi-supervised learning, unsupervised learning can be used in order to train the machine learning model. In unsupervised learning, (only) input data may be provided and an unsupervised learning algorithm can be used to find a structure in the input data (for example, by grouping or clustering the input data, finding commonalities in the data). Clustering is the assignment of input data comprising a plurality of input values into subsets (clusters) so that input values within the same cluster are similar according to one or more (predefined) similarity criteria, while they are dissimilar to input values comprised in other clusters.

Reinforcement learning is a third group of machine learning algorithms. In other words, reinforcement learning can be used to train the machine learning model. In reinforcement learning, one or more software actors (i.e., “software agents”) are trained to perform actions in an environment. A reward is calculated based on the actions performed. Reinforcement learning is based on training one or more software agents to select actions such that the cumulative reward is increased, resulting in software agents that become better at the task given to them (as evidenced by increasing rewards).

Furthermore, some techniques can be applied to some of the machine learning algorithms. For example, feature learning can be used. In other words, the machine learning model may be trained at least in part using feature learning, and/or the machine learning algorithm may comprise a feature learning component. Feature learning algorithms, referred to as representation learning algorithms, can preserve the information in their input but transform it in a way that makes it useful, often as a preprocessing stage before performing classification or prediction. Feature learning can, for example, be based on principal component analysis or cluster analysis.

In some examples, anomaly detection (i.e., outlier detection) may be used, which aims to provide identification of input values that raise suspicion because they differ significantly from the majority of input data and training data. In other words, the machine learning model may be trained at least in part using anomaly detection, and/or the machine learning algorithm may comprise an anomaly detection component.

In some examples, the machine learning algorithm may use a decision tree as a prediction model. In other words, the machine learning model can be based on a decision tree. In a decision tree, the observations about an object (e.g., a set of input values) can be represented by the branches of the decision tree, and an output value corresponding to the object can be represented by the leaves of the decision tree. Decision trees can support both discrete values and continuous values as output values. If discrete values are used, the decision tree can be referred to as a classification tree; if continuous values are used, the decision tree can be referred to as a regression tree.

Association rules are another technique that can be used in machine learning algorithms. In other words, the machine learning model can be based on one or more association rules. Association rules are created by identifying relationships between variables in large data sets. The machine learning algorithm can identify and/or use one or more ratio rules that represent the knowledge derived from the data. The rules can be used, for example, to store, manipulate or apply the knowledge.

Machine learning algorithms are usually based on a machine learning model. In other words, the term “machine learning algorithm” can refer to a set of instructions that can be used to create, train, or use a machine learning model. The term “machine learning model” may refer to a data structure and/or a set of rules that represents the learned knowledge (e.g., based on the training performed by the machine learning algorithm). In exemplary embodiments, the use of a machine learning algorithm may imply the use of an underlying machine learning model (or a plurality of underlying machine learning models). The use of a machine learning model may imply that the machine learning model and/or the data structure/set of rules that constitutes the machine learning model is trained by a machine learning algorithm.

For example, the machine learning model can be an artificial neural network (ANN). ANNs are systems inspired by biological neural networks, such as those found in a retina or a brain. ANNs comprise a plurality of interconnected nodes and a plurality of connections, so-called edges, between the nodes. There are usually three types of nodes, input nodes that receive input values, hidden nodes that are (only) connected to other nodes, and output nodes that provide output values. Every node can represent an artificial neuron. Every edge can send information from one node to another. The output of a node can be defined as a (non-linear) function of the inputs (for example the sum of its inputs). The inputs of a node can be used in the function based on a “weight” of the edge or node providing the input. The weight of nodes and/or edges can be adjusted as part of the learning process. In other words, training an artificial neural network can comprise adjusting the weights of the nodes and/or edges of the artificial neural network, i.e., in order to achieve a desired output for a certain input.

Alternatively, the machine learning model can be a support vector machine, a random forest model or a gradient boosting model. Support vector machines (i.e., support vector networks) are supervised learning models with associated learning algorithms that can be used to analyze data (for example, in a classification or regression analysis). Support vector machines can be trained by providing an input with a plurality of training input values belonging to one of two categories. The support vector machine can be trained in order to assign a new input value to one of the two categories. Alternatively, the machine learning model can be a Bayesian network, which is a probabilistic-directed, acyclic graphical model. A Bayesian network can represent a set of random variables and their conditional dependencies using a directed acyclic graph. Alternatively, the machine learning model can be based on a genetic algorithm, which is a search algorithm and heuristic technique that mimics the process of natural selection.

### LIST OF REFERENCE SIGNS

101 Step of checking whether a ratcheting error has been received from a joint
102 Step of correcting a value for a currently occupied angle
103 Step of updating corresponding variables for current end effector positions of the cobot
104 Step of recalculating or updating a trajectory that the joint is to traverse in the future
105 Step of returning the central control unit to a normal mode
110 End of flow chart
201 Step of loading time behavior data into a calculation buffer
202 Step of determining whether ratcheting has occurred at the joint
203 Decision point pertaining to whether ratcheting has occurred at the joint
204 Step of outputting a corresponding ratcheting error code to a communication bus
210 End of flow chart

1. A method for the detection of ratcheting during operation of a robot in relation to at least one joint of the robot, on the basis of operating data of the robot by means of artificial intelligence, comprising the steps of:
providing operating data in relation to a time behavior of a motor of the robot; and
detecting ratcheting of a joint of the robot by evaluation of the operating data as indirect or direct input data for an artificial intelligence system yielding output data,
wherein the output data of the artificial intelligence system comprise an indicator which indicates whether ratcheting has occurred in relation to the joint.

2. The method of claim 1, wherein the artificial intelligence uses a technique of supervised or semi-supervised learning.

3. The method of claim 1, wherein the output data further indicate an extent of ratcheting that has occurred.

4. The method of claim 3, further comprising a step of calculating at least one of a corrected trajectory and a corrected control instruction based on the extent of ratcheting indicated by the output data.

5. A collaborative robot, comprising:
a robotic device
having a joint operable to be moved by a motor; and
a motor control unit for controlling the motor,
wherein the collaborative robot is further configured to use an artificial intelligence system to detect ratcheting of the joint by evaluating operating data in relation to a time behavior of the motor as indirect or direct input data for the artificial intelligence system,
wherein the operating data comprises current flow data.

6. The collaborative robot of claim 5, wherein the artificial intelligence system is designed to provide output data which comprise an indicator which indicates whether ratcheting has occurred in relation to the joint.

7. The collaborative robot of claim 6, wherein the output data further indicate an extent of ratcheting that has occurred by indicating at least one of a number of teeth that were skipped in a gear mechanism during ratcheting and an angle skipped by the ratcheting.

8. The collaborative robot of claim 7, wherein the collaborative robot is further configured to calculate at least one of a corrected trajectory and a corrected control instruction based on at least one of the number of teeth skipped during ratcheting and the angle skipped by the ratcheting indicated via the output data.

9. The collaborative robot of claim 5, further comprising:
a central control unit in communication with the motor control unit via bus, wherein the motor control unit is configured to determine whether ratcheting has occurred in relation to the joint and a number of teeth which were skipped in a gear mechanism during ratcheting, and wherein the central control unit is configured to calculate at least one of a corrected trajectory and a corrected control instruction.

10-14. (canceled)

15. A method for training an artificial intelligence system to determine at least one of (1) the presence or absence of ratcheting of a gear mechanism of a collaborative robot having a motor and (2) a number of teeth that were skipped in the gear mechanism during ratcheting, comprising the steps of:
receiving, at one or more neurons of the artificial intelligence system, input data comprising data based on operating data relating to a time behavior of the motor of the collaborative robot; and
utilizing the received input data to facilitate machine learning pertaining to determining at least one of (1) the presence or absence of ratcheting of the gear mechanism of the collaborative robot having the motor and (2) the number of teeth that were skipped in the gear mechanism during ratcheting.

16. The method of claim 15, wherein the operating data is current flow data.

17. The method of claim 16, wherein the input data includes a plurality of data sets comprising the data based on the operating data relating to the time behavior of the motor of the collaborative robot provided with classifying labels as to whether the data corresponds to ratcheting that has or has not occurred.

18. The method of claim 17, wherein the classifying labels further indicate a number of teeth skipped in a ratcheting corresponding to the data.
